(19) United States
(12) Patent Application Publication
(10) Pub. No.: US 2025/0053561 A1
(43) Pub. Date: Feb. 13, 2025

(54) METHOD AND SYSTEM FOR PROBABILISTIC QUERYING OF A VECTOR GRAPH DATABASE

(71) Applicant: Verses AI, Inc., Vancouver (CA)

(72) Inventors: Alexander Tschantz, West End (AU); Ozan Catal, Ghent (BE); Mahault Albarracin, Montreal (CA); Riddhi Jain Pitliya, Oxford (GB); Tim Verbelen, Dendermonde (BE); Robert Conor Heins, Berlin (DE); Tommaso Salvatori, Vienna (AT); Axel Constant Pruvost, Montreal (CA); Christopher L. Buckley, Brighton (GB); Alexander B. Kiefer, Arverne, NY (US); Sara K. Brazille, Montreal (CA); Magnus T. Koudahl, Eindhoven (NL); Jason G. Fox, Dallas, TX (US); Karl J. Friston, Rickmansworth (GB); Stephan A. Swanson, Culver City, CA (US); Capm Petersen, Los Angeles, CA (US); Gabriel Joseph Bradley Rene, Los Angeles, CA (US); Maxwell J. Ramstead, Montréal (CA)

(21) Appl. No.: 18/783,398

(22) Filed: Jul. 24, 2024

Related U.S. Application Data
(60) Provisional application No. 63/515,573, filed on Jul. 25, 2023.

(51) Int. Cl. G06F 16/242; G06F 16/21; G06F 16/22; G06F 16/25

(52) U.S. Cl. CPC G06F 16/2433; G06F 16/211; G06F 16/2237; G06F 16/252

(57) ABSTRACT

A method and system for performing predictive querying on vector graph document database that includes entities wherein each entity has a Unique IDentifier (UID) tag field, and a schema or array of schema fields, the method including performing probabilistic querying by means of data links that include source, destination, transform, program and data fields, the transform field including a data subfield that refers to the probabilistic, conditional relation between two entities, and a program subfield that defines an infer method and a learn method.

### FIELD OF INVENTION

This application explores database querying languages

### BACKGROUND

Databases are queryable data stores. The three common classes of databases are the relational databases, the graph databases, and the vector databases. Relational databases store data in a way that allows querying by comparing properties of the various stored entities (e.g., “give me the people whose age is greater than 25”). Graph databases store data in a way that allows for querying by looking at the relation between the stored entities (e.g., “give me the children entities to the Steve entity). Vector databases store vectorized representations of the entities so as to allow for querying based on mathematical operations such as cosine similarity (e.g., “give me the nearest object to the sunglasses entity). Vector graph document databases are databases whose structure allows for mix queries combining relational, graph, and vector databases type queries (e.g., “give me the products whose prices are greater than 5 dollars and that are sold by the company X, and whose description best matches that of sunglasses”).

Probabilistic queries are an approach to database retrieval that seeks to provide responses that can be ranked relevant to the subject and context—both explicit and implicit—of the query statement (e.g., returning a ranking of the top answers for “give me the best restaurants in this area”). Probabilistic queries use measures of relevance based on the probability of data in the database (e.g., restaurant location) to fit the underlying intention of the query even if they are not explicitly specified in the query statement (e.g., “best” might implicitly mean 3+ star rating). Probabilistic queries infer information about the query statement itself as well as context provided by data in the database, though indirectly related to the query (e.g., proximity to an event the querier will attend), querier preferences (e.g., gluten-free menu options). Alongside richer data, more robust data architectures (e.g., a rich vector graph document database vs. a simple relational database) can result in more relevant and useful results. It can also pull information from external sources (e.g., social media or user-provided profile information).

### BRIEF DESCRIPTION OF THE DRAWINGS

FIG. 1 illustrates the syntax of a HSML vector graph document database;

FIG. 2 illustrates the HSML vector graph document database in FIG. 1 applied to an illustrative scenario;

FIG. 3 illustrates the structure of the data referred to in the data subfield of each link presented in FIG. 2;

### SUMMARY OF THE INVENTION

The claimed method provides a method for performing probabilistic queries on vector graph document databases using an inference algorithm. In one embodiment of this invention, the claimed method returns the result of a query to a vector graph document database implementing the Hyperspace Modeling Language (HSML)—defined below—that most probably matches the user's goal (e.g., returning the most probable brand, model, feature set, and location to a query for “cheap sunglasses”).

### Definitions

A knowledge graph represents entities in the world and the relationships between them. Entities are any physical or conceptual “thing” that has meaning in the real world (e.g., a robot, a sofa, a waypoint in space that refers to a location where one can go, a specification of an activity, etc.). Relationships between entities are expressed by links that make explicit the relation between entities. When using a Hyperspace Modeling Language (HSML)—defined below-implemented as a factor graph—defined below—knowledge graphs treat both links and entities as types of entities, and may also be referred to herein as link entities (or edges) and variable entities (or nodes), respectively. Some of those link entities are called “data links” and are able to perform operations on the nodes, or “variable entities” they relate. In this case, the properties of data link entities are defined as functions over relations between properties of variable entities.

Hyperspace Modeling Language (HSML) is herein defined as a structured modeling language used to link entities in a knowledge graph. The syntax of HSML includes 1 main entity type and 4 entity subtypes. All entities are documents written in JSON format. The main entity document (e.g., for an object such as “Ray-Ban sunglasses in a warehouse”) includes a Unique IDentifier (UID) tag field called Spatial Web Unique IDentifier (SWID), a name field (optional), a description field (optional), and a schema, or array of schema field (denoted as @schema).

The schema is the first document subtype. It contains a vectorization field which indicates how to convert the entity, to which the schema belongs, into a vector representation of that entity (i.e., vectorization strategy). The vectorization field is an array of objects that contains information about the entity's properties, a vectorization program (i.e., algorithmic operations) to vectorize the entity, and a vector space.

The vector space is the second subtype, and describes the structure that contains the vectors of the vectorized entity. Vector spaces have two fields, which are the distance metric field (e.g., cosine distance between vectors) and the length field (i.e., vector dimensionality).

The third subtype is the link. A link is a relation between two entities (e.g., “Ray-Ban sunglasses” are sold by “the company X”) and contains a source—entity—UID field and a destination—entity—UID field. HSML allows for two types of links: normal links and data links. Normal links provide parent-child relationships information between entities. Data links are links that allow for performing operations on entities and contain a transform field, which links to a program that can perform an operation between entities (e.g., decrement the amount of sunglasses by 1 when selling a pair).

Data link programs are the fourth and final subtype, and include two fields, which are the program field—indicating the program to be executed—and the data field—indicating the type of data over which the program should execute.

A factor graph consists of two types of nodes: factor nodes, which represent factors or functions that relate multiple variables together, and variable nodes, which represent the variables in the model. The factor nodes are connected to the variable nodes that they depend on, and the graph structure reflects the conditional dependencies between the variables. For the factor graphs used in this document, we use a bipartite graph representation and partition the graph into factor nodes and variable nodes. Variable nodes are denoted by circles and correspond to variables in the probabilistic generative models over which the inference algorithm applies. Variable nodes are entities of the HSML vector graph document database. Factor nodes are denoted by squares and denote the relation between variables, or entities. In the context of this invention, they encode the data that represents the probabilistic relation between entities, and that can be used by an inference program to perform probabilistic querying.

The HSML vector graph document database is a queryable database using the syntax of an HSML knowledge graph. An HSML knowledge graph is a special implementation of a knowledge graph using the HSML syntax. The HSML vector graph document database is treated as a factor graph thereby allowing for performing inferences about the relation between the entities contained in the database. Predictive querying over HSML vector graph document databases involves implementing a data link whose program allows the user to infer (i.e., predict) the probability of relevant responses and to learn (i.e., update) the statistical model implemented by the program of the data link. This is described in detail below.

In one embodiment of this invention, the code for the data link programs allowing for predictive querying on HSML vector graph document databases is implemented as a class in the Python programming language and is composed of an infer method, which infers the probability of linked entities to be relevant to the query, and a learn method, which updates the probabilities in the model implemented by the program responsible for the inference when a relation between entities is observed.

### DETAILED DESCRIPTION

As an illustration of predictive querying, we present the description of the claimed method within the context of an HSML vector graph document database that contains data that can be queried to get information about sunglasses. We assume that the database contains information about various entities, which are the brands of sunglasses (Ray-Ban, Oakley, and Smith), the possible shelf locations where the glasses can be found (Shelf 1, 2 and 3), and the possible prices for the sunglasses ($10, $50, $50). We also assume, as may be the case in various real world scenarios, that there is uncertainty over the relation between the different entities. For instance, there may be items at different price points on different shelves, meaning that there may be an equal probability of finding $50 items on shelves 1 and 3, and there may equally be chances of finding different brands on different shelves. The claimed method for predictive querying over HSML vector graph document databases allows returning the most probable combination of brand, shelf location and price when querying only one of the possible entities (e.g., asking for “which are sunglasses less than $10” and being answered that such sunglasses are probably Oakleys on shelf 3, but they might also be Smiths on shelf 1). Sample pseudo code using the Python programming language for implementing the example discussed here, is interspersed here for ease of understanding.

def on_variable_update(variable):
# Called whenever a variable is updated
# loop over all data links connected to this variable
for link in variable.data_links:
# calculate marginal for variable - i.e. product of all messages
normalised marginal = product_and_norm(variable.messages)
# update target factor with marginal
update_entity(link.target.messages, marginal)
def on_factor_update(factor):
# Called whenever a factor is updated
# loop over all data links connected to this factor
for link in factor.data_links:
# calculate marginal for factor
marginal = factor_marginal(factor.tensor, link.target)
# update target variable with marginal
update_entity(link.target.messages, marginal)

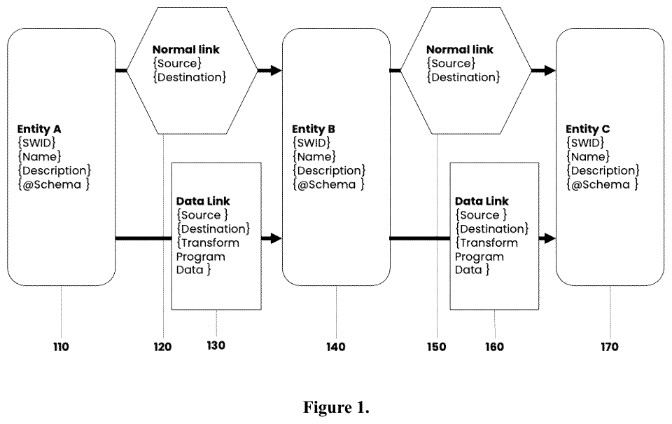

FIG. 1 illustrates the syntax of a HSML vector graph document database. 110 Presents an entity with a UID tag field, a name field (optional), a description field (optional), and a schema, or array of schema fields (denoted as @schema). 120 presents a normal link with source and destination fields, and that indicates that entity B is the child (i.e., destination) of entity A (i.e., source). 130 presents a data link that performs probabilistic querying, with source, destination, transform, program and data fields. 140 presents an entity B with a UID tag field, a name field (optional), a description field (optional), and a schema, or array of schema fields. 150 presents a normal link with source and destination fields, and that indicates that entity C is the child (i.e., destination) of entity B (i.e., source). 160 presents a data link that performs probabilistic querying, with source, destination, transform, program and data fields. 170 present an entity C.

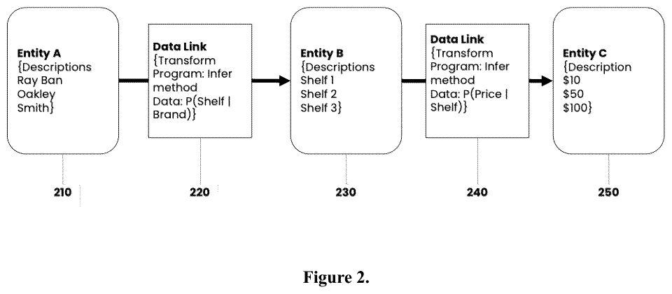

FIG. 2 is an illustration of the HSML vector graph document database in FIG. 1 applied to the illustrative scenario. 210 is an entity A corresponding to the brands of sunglasses whose descriptions include Ray-Ban, Oakley, and Smith. 220 is a data link with a transform field that includes a data subfield that refers to the probabilistic, conditional relation between the entity B and the entity A (i.e., the brands), and a program subfield that refers to the infer method and the learn method described below. 230 is an entity B corresponding to the shelf locations 1,2,3 of possible brands of sunglasses. The data subfield of the transform field of the data link in 220 maps the conditional relationship between shelf locations and the brands (e.g., The conditional Probability P that Oakley sunglasses sit on shelf 2, or P (shelf 2| Oakley sunglasses)). 240 is a data link whose data subfield refers to probabilities of the entities in C and the entities in B (i.e., the shelf locations). 250 indicates that the entities in C are price points for the sunglasses ($10, $50, $100). The conditional probabilities encoded by the data subfield of the data link in 240 corresponds to the probabilities of observing certain price points for items on the different shelves (P (prices| shelves)).

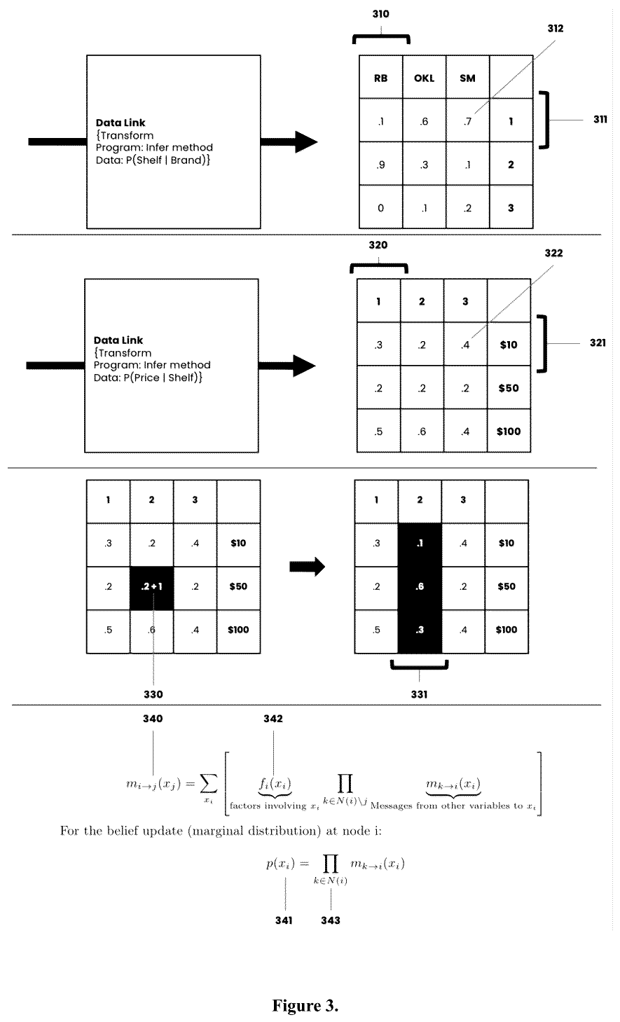

FIG. 3 illustrates the structure of the data referred to in the data subfield of each data link in 220 and 240. The data is about the conditional probabilities of observing a certain entity, or variable, relating to another entity, or variable, provided that those variables are related by a datalink, or edge. The probabilities are presented as mappings in matrices (or in tensors). 310 indicates that the column of each matrix corresponds to a probability distribution (i.e., must sum to 1). Each cell encodes a probabilistic mapping between the variable represented by the column (e.g., brands) and the variable represented by the rows (e.g., shelf number). 311 indicates the rows that represent the observed variable, or the children of an entity (e.g., the shelf numbers). 312 indicates that the probability of shelf 1 to contain smith (SM) glasses is 70% (0.7). This reflects the fact that in the database, each data subfield of the data link refers to the probability mapping of the children and parent entities, or variables, which here is encoded by the cells of the matrix. 320 also indicates that the column of each matrix corresponds to a probability distribution (i.e., must sum to 1). The same way, each cell encodes a probabilistic mapping between the variable represented by the column (e.g., brands) and the variable represented by the rows (e.g., shelf number). 321 indicates the rows that represent the observed variable, or the children of an entity, which in this case are the prices of the items on the shelf. 322 indicates that the probability of 10$ items to be found on shelf 3 is 40% (0.4). The claimed method for probabilistic querying on HSML vector graph document databases includes a learn method and an infer method operated in dynamic programming. The learn method corresponds to the update of the probability distribution represented by the columns of the data matrices after having observed an entity in relation to another (e.g., a robot observing 50$ items on shelf 2). The observation leads to 330 an increase in counts (e.g., +1) for the observed probability mapping. 331 indicates that the mappings of interest (e.g., the mappings between possible prices and shelf 2) are renormalized using a normalization method such as a sum and divide method. The infer method is operated by the inference algorithm referred to in the program subfield of the data link. The inference algorithm performs mathematical operations over the conditional probabilities encoded by the data subfields of the datalinks. If the query is “$50 items”, the inference method will return what brand of sunglasses at the warehouse can be found on what shelf at that price point. The algorithm implemented by the program of the data link is called the sum-product algorithm for belief propagation. This algorithm iterates over the data fields of the data links of the vector graph document databases that function as factors of a factor graph. Each iteration updates the posterior probability of entities until convergence is achieved. In the equation used to perform the update based on the factors, or data field that goes from node i (e.g., brands) to node j (e.g., shelf location), 340 corresponds to the message from node i to node j that equals the summation over all possible values of the entity i such as encoded by the data field of the data link. 341 is the marginal probability of node i. 342 is the factor associated with node i. 343 is the set of neighbors of node i.

What is claimed is:

1. A system for, encoding information of entities in a vector graph document database, comprising:
a processor on a computer system that can be used to interact with a database, and
a vector graph document database having a Hyper Space Modelling Language (HSML) structure and capable of computation over stored entities using data links, wherein the entities in the database can be created, read, updated, and deleted using create, read, update, and delete (CRUD) functionalities.

2. The system of claim 1, wherein the modeling language of HSML defines a Unique IDentifier (UID) tag field for each entity, wherein the entities include source entities and destination entities stored in the vector graph document database, a schema, normal links that relate at least some of the source entities with at least some of the destination entities according to their causal or parent-children relationships, and the data links, wherein the data links relate at least some source entities with at least some destination entities according to their causal or parent-children relationships and perform computations over the related entities.

3. The system of claim 2, wherein the schema comprises an array of schema fields.

4. A method performed by one or more computers for querying a database, comprising,
providing a vector graph document database having a Hyper Space Modelling Language (HSML) structure and capable of computation over stored entities using datalinks, wherein said entities include source and destination entities,
encoding the prior probability of entities in the vector graph document database,
receiving a user query,
inferring the posterior probability of the entities based on the user query,
updating parameters of the vector graph document database, wherein the parameters encode the probability of the relation between source and destination entities, and
returning the set of entities related to the user query.

5. The method of claim 4, wherein the parameters that encode the probability of the relation between source and destination entities use a vector, matrix, or tensor, with columns representing the source entity and rows representing the destination entity, and cells of the vector, matrix, or tensor containing the probability of the relationship between the source and destination entities.

6. The method of claim 5, wherein the HSML comprises a Unique IDentifier (UID) tag field for each entity, a schema, normal links that relate at least some of the source entities with at least some of the destination entities according to their causal or parent-children relationships, and data links that relate at least some source entities with at least some destination entities according to their causal or parent-children relationships and wherein the data links are capable of performing computation over the related entities.

7. The method of claim 6, wherein the schema comprises an array of schema fields.

8. The method of claim 6, wherein the inference is performed over the parameters of the vector graph document database.

9. The method of claim 8, wherein the algorithm to perform the inference is implemented by the data links of the vector graph database.

10. The method of claim 9, wherein the algorithm includes one or more of sum-product, belief propagation, variational message passing, Laplace propagation, and Expectation Propagation algorithms.

11. The method of claim 4, wherein the user query is received through create, read, update, and delete (CRUD) functionalities to communicate a database.

12. The method of claim 4, wherein the parameters of the vector graph document database are updated by adding a count of +1 to the value in the cell of the vector, matrix or tensor parameter representing the relationship between one or more entities connected to the entity referenced in the user query, and wherein the probability distribution of the vector, matrix or tensor is normalized after having added the count to ensure that the distribution sums to 1.

13. The method of claim 4, wherein results returned to the user are the most probable entities in the posterior probability distribution related to the user query.

14. The method of claim 13, wherein the threshold for considering an entity probable is set by a user.
